(19) United States
(12) Patent Application Publication
(10) Pub. No.: US 2015/0118437 A1
(43) Pub. Date: Apr. 30, 2015

(54) MOTOR VEHICLE PARTS

(71) Applicant: HP Pelzer Holding GmbH, Witten (DE)

(72) Inventors: Volkmar Schulze, Schierling (DE); Norbert Nicolai, Schermbeck-Gahlen (DE); André Feole, Vicenza (IT); Fabrizio Fornasa, Marano Vincentino (IT); Federica Filotto, Marano Vincentino (IT)

(21) Appl. No.: 14/398,919

(22) PCT Filed: Apr. 29, 2013
(86) PCT No.: PCT/EP2013/058865

§ 371 Date: Nov. 4, 2014

(30) Foreign Application Priority Data
May 9, 2012 (DE) 20 2012 004 594.6

(51) Int. Cl. B60R 13/08; D06N 7/00

(52) U.S. Cl. CPC B60R 13/083; D06N 7/0081; D06N 2201/02; D06N 2209/025
USPC 428/95; 181/294

(57) ABSTRACT

The invention relates to a motor vehicle part material structure for sound insulation for the motor vehicle interior and motor vehicle trunk, namely floor mats floor coverings, and trunk linings, that makes it possible to industrially implement complete reprocessing of the entire composite, in particular the fiber material. The motor vehicle part has a PIT fiber layer, an optional substrate layer made of PET and/or COPET, an optional PET adhesive layer, a PET adhesive layer, a layer made of PET fiber nonwoven & brie or woven fabric, and an insulating layer made of PET/COPET.

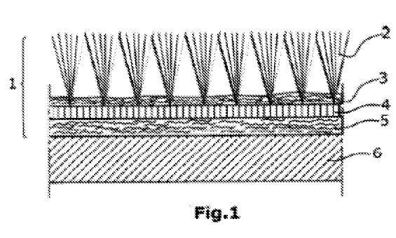

### FIELD OF THE INVENTION

The present invention relates to a motor vehicle part material structure for sound insulation for the motor vehicle interior and motor vehicle trunk, namely floor mats, floor coverings, and trunk linings, that makes it possible to industrially implement complete reprocessing of the entire composite, in particular the fiber material.

Motor vehicle parts within the meaning of the present invention include fitted carpets, in particular. These are inherent parts of a motor vehicle. Their structure usually consists of three different “layers”.

The wearing surface, which consists of yarns or fibers and optionally a support, is facing toward the passenger. The fibers may usually be either natural (animal: new wool, plant: cotton or jute) or synthetic (polyamide (PA), polyester (PET), polypropylene). Mixed yarns are also possible, such as polyamide and new wool. Also, “heavy duty” wearing surfaces predominantly consisting of non-crosslinked and crosslinked TPO, with and without surface “grain”, are employed.

The “middle layer” mostly consists of one or more adhesive compositions by means of which the fiber construction is fixed in the support fabric. Mostly, a synthetic rubber (SBR latex) serves as the adhesive. However, natural latex may also serve as the adhesive. Often, a second adhesive layer is used in order to incorporate/bond the backing material, which mostly consists of synthetic or natural latex again. Also, PVC (polyvinyl chloride) may bond together the wearing surface and the backing layer; PE (polyethylene), EVA (ethylene vinyl acetate) and PP (polypropylene) are further employed.

The backing layer is usually also made of foamed SBR latex. However, a mixture of non-foamed synthetic and natural latex is also used sometimes. Textile backings of natural fibers, such as jute, and mixed fibers are also utilized. Further, sealing films and heavy sheets as well as contact layers are found.

The reprocessing of such heterogeneous motor vehicle parts, especially fitted carpets, which are made of a wide variety of materials, is problematic.

In the motor vehicles currently on the market, different manifestations of fitted carpets are found, especially tufting, dilour and flat needle punch carpets. For a tufting carpet, PA6.6, PA6, PP, rPA (recycled polyamide) and rPET (recycled polyethylene terephthalate) are predominantly employed; and for the dilour and flat needle punch carpets, PET, PET/PP, PP and rPET are predominantly employed.

In the tufting grades, the tufting support is made of PET/PP, PET/coPET or PET/PA. In a tufting carpet, predominantly EVA, and in the dilour and flat needle punch carpets, predominantly SBR-latex or acrylate are employed for the yarn/fiber bonding. The coating, mostly as an adhesive layer for underlayer fabrics, but also for stiffening, predominantly includes PE or PP; optionally also a heavy layer based on EVA, PE, PP, EPDM (ethylene-propylene-diene monomer). The underlayer fabrics mostly include PET or cotton mixed fiber fabrics.

The insulation, especially in the floor covering system, may be a foam on the one hand, and a fibrous web on the other. For the foams, viscoelastic or highly elastic, and also light foams in singular cases, are employed. When foams are used, sealing films, nonwoven/films or so-called contact fabrics are employed between the top fabric and the foam insulation. In the nonwoven insulations, non-deformed (planar), predeformed tiles as well as insulations produced in a fiber flock process are found.

Such floor covering systems are described, for example, in DE 10 2004 046 201 A, DE 103 60 427 A, DE 199 60 945 A, and DE 10 2007 036 952 A.

US 2008/0220200 A, US 2008/0223654 A and US 2008/0292831 A describe carpet/floor covering systems in which the tufted top fabric and the insulation are based on PET. The tufting support preferably consists of PET, a polyolefin fiber (PE), or another suitable synthetic fiber. The bonding of the yarn is effected by means of foamed latex or acrylate as well as PE. PE or an EVA/PE mixture are applied as further coating materials in a web. In the bonding method using PE extrusion (directly extruded PE sheet/layer), the fibers are partially melted, thus forming a “rigidly” entangled pile/fiber underside. Also, the bonding material (PE) can partially permeate the fibrous web only conditionally. When the carpet is deformed, breaking may occur in the “rigidly” entangled pile/fiber underside, thus drastically deteriorating the wearing performance and, of course, the appearance. The floor covering and the trunk lining are thus unusable. Especially in US 2008/0223654 A, heavy sheets, PVC/EVA/PE are applied in composites; further, perforated and non-perforated sheet layers of PA, PE and/or PET are employed.

The technical solutions known in the prior art are not “one-material systems”; these composites include a wide variety of different polymers. In particular, SBR-latex and acrylate are employed for fiber bonding in addition to PE and EVA, which practically precludes reprocessing of the composite. Thus, an optimum reprocessing of the fiber material cannot be realized.

Further, yarn bonding by means of a sheet or extrusion sheet in a tufting carpet has the following disadvantage: In order to achieve bonding between the PET fibers or the yarn tuft at the underside of the carpet, the latter must be partially melted in practice. However, this has the consequence that the yarn tuft is not only bonded in a plasticized way, but also partially melted in a “glass-like” way in the lower part thereof. This also explains the deterioration of the abrasion values, and thus the higher wear. The individual fiber loses its good technological properties (elongation, tear-out force etc.) over a short, but important distance; and this may increasingly lead to broken fibers under load conditions. The rigid extrusion sheet (rigid fixation) tends towards a “bimetal effect” in the molded part; lower dimensional stability in temperature variations; also a risk of fiber/filament breakage.

Of course, this also applies to needle punch carpets, in which individual fibers rather than yarn tufts are present, however.

### SUMMARY OF THE INVENTION

It is the object of the present invention to realize a carpet material structure for sound insulations that can be reprocessed (recycled) by 100% in a relatively simple way; involving a reduction of the total fabric weight and the achieving of acoustic (absorptive) advantages.

According to the invention, this object is achieved, in particular, by the fact that the carpet material structure consists of PET fibrous material having a high content of recycled material, and that the fiber bonding agent is a PET dispersion, in particular. This application of the foamed fiber bonding agent allows for both achieving optimum bonding (flexible), and using a steam/heat process for completely shrinking the yarn, and achieving an optimum bulk of the fibers.

A first embodiment of the invention consists in a fitted carpet for a motor vehicle that is characterized in that:
(a) the wearing surface consists of polyethylene terephthalate (PET) yarns and/or fibers;
(b) the optional support layer, if present, is made of polyethylene terephthalate and/or a copolymeric polyethylene terephthalate;
(c) an optional first adhesive layer, if present, is made of a polyethylene terephthalate-based adhesive;
(d) the adhesive layer (middle layer) is made of a polyethylene terephthalate-based adhesive;
(e) the backing layer is made of a polyethylene terephthalate-based fibrous web or fabric; and
(f) the insulation layer is made of PET/coPET fibers.

### BRIEF DESCRIPTION OF THE DRAWING

The FIGURE of the drawing is a cross section of a carpet of the present invention as described in Example 1.

### DESCRIPTION OF THE INVENTION

A first embodiment of the invention consists in a fitted carpet for a motor vehicle that is characterized in that:
(a) the wearing surface consists of polyethylene terephthalate (PET) yarns and/or fibers;
(b) the optional support layer, if present, is made of polyethylene terephthalate and/or a copolymeric polyethylene terephthalate;
(c) an optional first adhesive layer, if present, is made of a polyethylene terephthalate-based adhesive;
(d) the adhesive layer (middle layer) is made of a polyethylene terephthalate-based adhesive;
(e) the backing layer is made of a polyethylene terephthalate-based fibrous web or fabric; and
(f) the insulation layer is made of PET/coPET fibers. According to the present invention,
   it is particularly preferred that a PET-based dispersion is employed for bonding the PET yarn (tufting)/the PET fibers (dilour, flat needle punch carpet), and for further optional adhesive layers. Thus, simple handling is possible in the production, and the composite, especially the raw materials, can be optimally recycled by 100%. The fiber bonding is flexible, and the individual fibers are bonded at points rather than (rigidly) fused together. Further, the material composite is 100% unmixed (PET); i.e., both the fibrous material and the bonding agent and adhesives are made of this material. In particular, this also applies to tufting, since the support is made of PET/coPET.

A PET dispersion as a bonding agent enables a good pile anchoring and adhesive embedding in the fibrous web at relatively low (processing) temperatures. Thus, the flexibility of the carpet/carpet composite is substantially retained; optimum abrasion values are reached.

When the bonding agent (PET dispersion) is applied, the aqueous fraction evaporates, and thus the complete shrinking of the yarn/fibers is achieved (automatically) with an optimum surface effect.

One advantage of the PET dispersion coating with a selectively adjusted melting range, i.e., low temperature, is that there is no partial melting of the fibers/yarn. The fibers have a high flexibility, and a rather homogeneous mass; and thus, there is no “bimetal effect”.

The kind of fitted carpet structure of the present invention can be determined by the respective circumstances. Primarily, according to the present invention, a fitted carpet is prepared from a tufting, dilour or flat needle punch top fabric, and one or more adhesive and non-woven layers, and an insulation, a non-woven insulation. Thus, the whole system is PET-based, and in particular, the tufting support is a PET/coPET staple fiber non-woven or spunbonded web. Also, the fiber/yarn bonding and the adhesive layers are based on PET dispersions. The PET fibers may consist of recycled PET in order to safeguard material resources. In addition, it is naturally also possible to produce PET fibers from virgin PET or even from mixtures of virgin and recycled PET.

According to the present invention, it is particularly preferred to prepare the fiber/yarn bonding and the adhesive layers respectively in the form of a PET powder/water dispersion, having adjustable melting points.

According to the present invention, it is particularly preferred if the underlayer fabrics are based on PET/rPET absorption/stiffening non-wovens, optionally also containing recycled PET fibers. For a good sound absorption, it is particularly preferred within the meaning of the present invention if the overall system of sound insulation is (acoustically) open-flow.

In the same way as the fitted carpets discussed above, floor mats, seat backs, side trims, interior trims and trunk linings can also be designed according to the present invention.

In the following, the invention is illustrated by means of Examples.

### EXAMPLES

### Example 1

A tufting carpet 1 was produced with a PET/rPET yarn size 2 of 1020 dtex, 127 filaments and a partition of 5/64″ utilizing a 120 g/m² PET/coPET support 3 with a pile yarn final weight (pile 2) of 305 g/m². The bonding was effected by means of roller coating of 100 g/m² of coPET dispersion 4; a 360 g/m² PET/coPET non-woven 5 was laminated thereon to improve the absorption/stiffening performance. The forming of the composite into a motor vehicle floor covering was performed using a fully automatic thermoforming machine in the process steps of cutting the carpet and non-woven to length, laminating in a laminating hot press, followed by heating in an IR heating field, followed by forming. The test of abrasion as one of the quality characteristics yielded 0.180 g.

Test conditions by analogy with DIN 53 754

| according to | cycles N | 1000 | |
|---|---|---|---|
| PrA-014 | revolutions per minute n | 60 | rpm |
| | load F | 2 × 1000 | g |

| | | |
|---|---|---|
| | abrasion wheel type | H18 |
| desired values: | abrasion | ≦0.3 |

### Example 2

Another tufting carpet 1 was produced with a PET/rPET yarn size 2 of 1300 dtex, 127 filaments and a partition of 1/10″ utilizing a 120 g/m² PET/coPET support 3 with a pile yarn final weight of 305 g/m². The bonding was effected by means of roller coating of 100 g/m² of coPET dispersion 4; a 360 g/m² PET/coPET non-woven 5 was laminated thereon to improve the absorption/stiffening performance. The forming was performed as in Example 1. The abrasion test yielded 0.210 g.

### Example 3

By a fiber flock process, corresponding PET/rPET fiber insulations 6 with a 15% PET/BiCo fiber proportion were produced.

Thus, the floor covering system (top fabric+insulation) consisted of a PET one material system. A complete reprocessing is possible. Thereby, and by the use of recycling PET (rPET) fibers, the requirements of “sustainability” and “green technology” are fully met.

### Example 4

A dilour carpet (not shown) was produced with 6.7/11 dtex PET/rPET fibers 2; and a 100 g/m² coPET dispersion 4 was applied by means of a padding machine. In this case too, a 360 g/m² PET/coPET non-woven 5 was laminated thereon to improve the absorption/stiffening performance. In addition to the PET/rPET fiber mix, PET/BiCo (bico=bicomponent) fibers were also employed in the composite.

The forming was performed as in the first Example. The abrasion test yielded 0.260 g.

1-6. (canceled)

7. A fitted carpet or floor covering (1) comprising a wearing surface (2) of a tufting, dilour or flat needle punch top fabric, or trunk lining, characterized in that:
(a) the wearing surface (2) consists of polyethylene terephthalate (PET) yarns/fibers and/or BiCo PET fibers;
(b) an optional support layer (3), if present, is made of polyethylene terephthalate and/or a copolymeric polyethylene terephthalate;
(c) a first adhesive layer (4) is made of a polyethylene terephthalate-based adhesive;
(d) further optional adhesive layers (middle layer) (4), if present, are made of a polyethylene terephthalate-based adhesive;
(e) a backing layer (5) is made of a polyethylene terephthalate-based, and optionally BiCo PET fiber-based, fibrous web or fabric; and
(f) an insulation layer (6) is made of PET/coPET fibers as well as BiCo PET fibers.

8. The fitted carpet or floor covering or trunk lining according to claim 7, characterized by a tufting support (3) including a PET/coPET staple fiber non-woven or a spunbonded web.

9. The fitted carpet or floor covering or trunk lining according to claim 7, characterized in that said fiber/yarn bonding agent (4) and adhesive layers (4) comprise a PET and/or coPET dispersion.

10. The fitted carpet or floor covering or trunk lining according to claim 8, characterized in that said fiber/yarn bonding agent (4) and adhesive layers (4) comprise a PET and/or coPET dispersion.

11. The fitted carpet or floor covering or trunk lining according to claim 7, characterized in that said PET fibers (2) comprise, especially consist of, virgin or recycled PET or mixtures thereof, and BiCo PET.

12. The fitted carpet or floor covering or trunk lining according to claim 8, characterized in that said PET fibers (2) comprise, especially consist of, virgin or recycled PET or mixtures thereof, and BiCo PET.

13. The fitted carpet or floor covering or trunk lining according claim 9, characterized in that said PET fibers (2) comprise, especially consist of, virgin or recycled PET or mixtures thereof, and BiCo PET.

14. The fitted carpet or floor covering or trunk lining according to claim 7, characterized in that said fitted carpet or floor covering or trunk lining comprise a fiber/yarn bonding agent (4), and said adhesive layers (4) comprise a PET and/or coPET powder/water dispersion with an adjustable melting point.

15. The fitted carpet or floor covering or trunk lining according to claim 8, characterized in that said fitted carpet or floor covering or trunk lining comprise a fiber/yarn bonding agent (4), and said adhesive layers (4) comprise a PET and/or coPET powder/water dispersion with an adjustable melting point.

16. The fitted carpet or floor covering or trunk lining according to claim 9, characterized in that said fitted carpet or floor covering or trunk lining comprise a fiber/yarn bonding agent (4), and said adhesive layers (4) comprise a PET and/or coPET powder/water dispersion with an adjustable melting point.

17. The fitted carpet or floor covering or trunk lining according to claim 11, characterized in that said fitted carpet or floor covering or trunk lining comprise a fiber/yarn bonding agent (4), and said adhesive layers (4) comprise a PET and/or coPET powder/water dispersion with an adjustable melting point.

18. The fitted carpet or floor covering or trunk lining according to claim 7, characterized in that the overall system of sound insulation is (acoustically) open-flow.

19. The fitted carpet or floor covering or trunk lining according to claim 8, characterized in that the overall system of sound insulation is (acoustically) open-flow.

20. The fitted carpet or floor covering or trunk lining according to claim 9, characterized in that the overall system of sound insulation is (acoustically) open-flow.

21. The fitted carpet or floor covering or trunk lining according to claim 11, characterized in that the overall system of sound insulation is (acoustically) open-flow.

22. The fitted carpet or floor covering or trunk lining according to claim 14, characterized in that the overall system of sound insulation is (acoustically) open-flow.
